(19) United States
(12) Patent Application Publication
(10) Pub. No.: US 2015/0056580 A1
(43) Pub. Date: Feb. 26, 2015

(54) PRONUNCIATION CORRECTION APPARATUS AND METHOD THEREOF

(71) Applicant: SELI INNOVATIONS INC., Seoul (KR)

(72) Inventors: Jin Ho KANG, Seoul (KR); Moon Kyoung CHO, Seoul (KR); Yong Min LEE, Seoul (KR)

(73) Assignee: SELI INNOVATIONS INC., Seoul (KR)

(21) Appl. No.: 14/467,671

(22) Filed: Aug. 25, 2014

(30) Foreign Application Priority Data
Aug. 26, 2013 (KR) 10-2013-0101319

(51) Int. Cl. G09B 5/02; G09B 19/06; G10L 25/03; G10L 25/48; G10L 21/10

(52) U.S. Cl. CPC G09B 5/02; G10L 25/48; G10L 21/10; G10L 25/03; G09B 19/06; G10L 2021/105
USPC 434/157

(57) ABSTRACT

The present invention provides a pronunciation correction method for assisting a foreign language learner in correcting a position of a tongue or a shape of lips when pronouncing a foreign language. According to a implementation of this invention, the pronunciation correction method comprises receiving an audio signal constituting pronunciation of a user for a phonetic symbol selected as a target to be practiced, analyzing the audio signal, generating a tongue position image according to the audio signal based on the analysis results, and displaying the generated tongue position image.

### CROSS-REFERENCE TO RELATED APPLICATION

This application claims priority from Korean Patent Application No. 10-2013-0101319 filed on Aug. 26, 2013 in the Korean Intellectual Property Office, the contents of which in its entirety are herein incorporated by reference.

### BACKGROUND

1. Technical Field

The present inventive concept relates to a pronunciation correction apparatus and a method thereof, and more particularly to a pronunciation correction apparatus for assisting a learner in confirming whether his/her pronunciation is correct and a method thereof

2. Description of the Related Art

Generally, foreign language pronunciation correction is made by one-to-one instruction with a foreign instructor. However, this language learning method is expensive and is not useful for those who live busy lives, such as office workers, because the instruction is done at a specified time. In order to solve this problem, a language learning machine having a variety of language learning programs using voice recognition has been developed and widely used.

However, conventional techniques for foreign language pronunciation correction have difficulties in visually representing how a learner actually pronounces a foreign language, or accurately representing a difference between the pronunciation of the learner and ideal pronunciation.

### SUMMARY

The present invention provides a pronunciation correction apparatus for assisting a foreign language learner in correcting a position of a tongue or a shape of lips when pronouncing a foreign language and a method thereof.

The pronunciation correction apparatus displays the position of the tongue on the screen when the user practices the pronunciation, thereby allowing the user to check whether the position of the tongue is wrong and correct his/her pronunciation. Also, the pronunciation correction apparatus displays the tongue standard position on the screen to further assist the correction.

Further, the pronunciation correction apparatus displays the shape of the lips on the screen when the user practices the pronunciation, thereby allowing the user to check whether the shape of the lips is wrong and correct his/her pronunciation. Also, the pronunciation correction apparatus displays the lip standard shape on the screen to further assist the correction.

According to one implementation of this invention, there is provided a pronunciation correction apparatus comprising a pronunciation analysis unit to receive an audio signal of a user and analyze pronunciation of the user; and a tongue position image generator to generate a tongue position image indicating a position of a tongue in the pronunciation of the user from the analysis results of the pronunciation analysis unit.

In one implementation, the tongue position image generator may estimate the position of the tongue in a side view based on the pronunciation analysis results of the pronunciation analysis unit.

In one implementation, the pronunciation correction apparatus may further comprise a standard pronunciation practice manager to determine a pronunciation analysis method based on a phonetic symbol specified as a target for pronunciation practice, wherein the pronunciation analysis unit analyzes the pronunciation by using the determined pronunciation analysis method. The pronunciation analysis unit may analyze formants of the pronunciation if the phonetic symbol specified as a target for pronunciation practice is a vowel, or a nasal or liquid consonant.

In one implementation, the pronunciation analysis unit may analyze a Fast Fourier Transform (FFT) spectrum of the pronunciation if the phonetic symbol specified as a target for pronunciation practice is a fricative consonant.

In one implementation, the pronunciation correction apparatus of claim 3, may further comprise a pronunciation evaluation unit to evaluate the pronunciation by linear predictive coding (LPC) waveform analysis if the phonetic symbol specified as a target for pronunciation practice is a liquid consonant.

In one implementation, the pronunciation correction apparatus may further comprise a tongue standard image storage unit to store a tongue standard position image for each phonetic symbol, a standard pronunciation display controller to output an input image to a display unit, and a standard pronunciation practice manager to read a tongue standard position image corresponding to the phonetic symbol specified as a target for pronunciation practice from the tongue standard image storage unit and output the tongue standard position image to the standard pronunciation display controller. In one implementation, the pronunciation correction apparatus may further comprise a face image processing unit to process a captured face image of the user, a lip shape display controller to display the processed image on the display unit. In one implementation, the pronunciation correction apparatus may further comprise a lip standard image storage unit to store a lip standard shape image for each phonetic symbol, wherein the standard pronunciation practice manager reads a lip standard shape image corresponding to the phonetic symbol specified as a target for pronunciation practice from the lip standard image storage unit and displays the lip standard shape image.

In one implementation, the pronunciation correction apparatus the face image processing unit may analyze the face image of the user to recognize a facial contour, and processes the image in the same form as the lip standard shape image.

According to another implementation, there is provided a pronunciation correction method comprise receiving an audio signal constituting pronunciation of a user for a phonetic symbol selected as a target to be practiced, analyzing the audio signal, generating a tongue position image according to the audio signal based on the analysis results, and displaying the generated tongue position image.

In one implementation, the displaying the generated tongue position image may comprise further displaying a tongue standard position image for the phonetic symbol.

In one implementation, the analyzing the audio signal may comprise, selecting one of a plurality of pronunciation analysis methods according to the phonetic symbol, and analyzing the audio signal by using the selected pronunciation analysis method.

In one implementation, the plurality of pronunciation analysis methods may include a method of analyzing formants of the pronunciation and a method of analyzing a Fast Fourier Transform (FFT) spectrum of the pronunciation.

In one implementation, the pronunciation correction method may further comprising evaluating the pronunciation of the user by linear predictive coding (LPC) waveform analysis if the selected phonetic symbol is a liquid consonant.

In one implementation, the evaluating the pronunciation of the user may comprise evaluating the pronunciation of the user by evaluating whether an interval between formant frequencies F2 and F3 of the pronunciation is equal to or less than a predetermined reference value if the selected phonetic symbol is [r].

In one implementation, the evaluating the pronunciation of the user may comprise evaluating the pronunciation of the user by further evaluating whether an interval between formant frequencies F1 and F2 of the pronunciation is within a predetermined range if the selected phonetic symbol is [r].

In one implementation, the pronunciation correction method may further comprise displaying a face image of the user pronouncing a phonetic symbol, and displaying a lip standard shape image for the phonetic symbol being pronounced by the user.

In one implementation, the analyzing the audio signal may comprise calculating formant frequencies F1 and F2 of the pronunciation of the user, and wherein the generating the tongue position image may comprise generating feature points corresponding to the formant frequencies F1 and F2, and generating the tongue position image by using the feature points as an application point and an end point of a tongue in a Bezier curve which is a curve in a length direction of the tongue when viewed from a side of a face.

### BRIEF DESCRIPTION OF THE DRAWINGS

The above and other aspects and features of the present inventive concept will become more apparent by describing in detail exemplary embodiments thereof with reference to the attached drawings, in which:

FIG. 1 is a block diagram of a pronunciation correction apparatus according to an embodiment of the present invention;

FIG. 2 is a diagram showing an example of a display screen representing the lip shape and the tongue position for phonetic symbol [i];

FIG. 3 is a diagram showing an example of a display screen representing the lip shape and the tongue position for phonetic symbol [a];

FIG. 4 is a diagram showing an example of a display screen representing the lip shape and the tongue position for phonetic symbol [r];

FIG. 5 is a diagram showing frequency-energy distribution on a FFT chart when pronouncing [θ];

FIG. 6 is a diagram showing an example of a display screen representing the lip shape and the tongue position for phonetic symbol [θ];

FIG. 7 is a diagram showing frequency-energy distribution on a FFT chart when pronouncing [s];

FIG. 8 is a diagram showing an example of a display screen representing the lip shape and the tongue position for phonetic symbol [s];

FIG. 9 is a diagram showing frequency-energy distribution on a FFT chart when incorrectly pronouncing [s];

FIG. 10 is a diagram showing an example of a display screen representing the lip shape and the tongue position in the case of FIG. 9;

FIG. 11 is a diagram showing frequency-energy distribution on a FFT chart when pronouncing [∫];

FIG. 12 is a diagram showing an example of a display screen representing the lip shape and the tongue position for phonetic symbol [∫];

FIG. 13 is a linear predictive coding (LPC) graph when pronouncing [r];

FIG. 14 is a LPC graph when incorrectly pronouncing [r];

FIG. 15 is a LPC graph when pronouncing [l]; and

FIG. 16 is a flowchart of a pronunciation correction method according to one embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail to enable those skilled in the art to easily understand and reproduce the present invention.

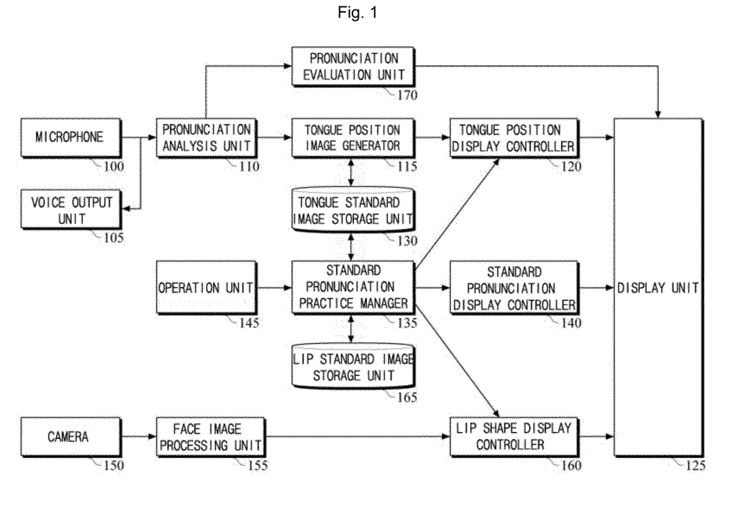

FIG. 1 is a block diagram of a pronunciation correction apparatus according to an embodiment of the present invention. The pronunciation correction apparatus may be an apparatus which is not specific to a particular language. In one embodiment, the pronunciation correction apparatus may be an apparatus for supporting pronunciation correction for a plurality of languages such as English, Chinese, German and French. A user may practice pronunciation, particularly, pronunciation for phonetic symbols after selecting a desired language, and may have the pronunciation corrected according to a pronunciation correction method which will be described later. As shown in FIG. 1, the pronunciation correction apparatus may include a microphone 100, a voice output unit 105, a pronunciation analysis unit 110, a tongue position image generator 115, and a tongue position display controller 120. The pronunciation analysis unit 110 and the tongue position image generator 115 may be a processor in hardware, and may be embodied as software modules executable by the processor. The tongue position display controller 120 may be implemented in a display driver IC. The microphone 100 may receive the voice of the user who pronounces English. The voice output unit 105 processes the voice inputted through the microphone 100 and outputs the processed voice to the outside. As is well known, the voice output unit 105 is a component including an amplifier and a speaker.

The pronunciation analysis unit 110 analyzes the pronunciation of the user inputted through the microphone 100. In this case, the pronunciation of the user may be pronunciation for phonetic symbols. In one embodiment, the pronunciation analysis unit 110 may analyze formants of the voice of the user. As is well known, tones of vowels are distinguished from each other according to the distribution of resonant frequency bands. The resonant frequency bands are referred to as a first formant F1, a second formant F2, and a third formant F3 from the low frequency side. The identification of vowels is most greatly related to the first formant F1 and the second formant F2. Further, it has been known that formants appear relatively well in consonants having acoustic properties similar to those of vowels, such as nasal and liquid consonants, in addition to vowels.

The tongue position image generator 115 may generate a tongue position image from the analysis results of the pronunciation analysis unit 110. In one embodiment, the tongue position image generator 115 may estimate the position of the tongue based on the frequencies of the formants F1 and F2 obtained from the formant analysis of the pronunciation analysis unit 110. For the estimation, information on the position of the tongue corresponding to the frequencies of the formants F1 and F2 in the standard pronunciation may be constructed in advance. In one embodiment, the tongue position image generator 115 may generate feature points indicating the position of the tongue by comparing the constructed information with the frequencies of the formants F1 and F2 obtained from the analysis of the pronunciation analysis unit 110. In one embodiment, the tongue position image generator 115 may estimate the position of the tongue in a side view of a face. The feature points may be used as an application point and an end point of the tongue in a Bezier curve which is a curve in a length direction of the tongue when viewed from the side. The tongue position image generator 115 may create a shape of the tongue by adjusting the relative positions of the application point and the end point of the tongue to be linked properly in accordance with the frequencies of the formants F1 and F2.

The tongue position display controller 120 displays the tongue position image generated by the tongue position image generator 115 on a display unit 125. The display unit 125 may be a liquid crystal display, an organic light emitting diode display or the like. If the tongue position image includes a plurality of images, the tongue position display controller 120 may represent movement of the tongue by sequentially outputting a series of tongue position images on the screen. In one embodiment, the tongue position display controller 120 may adjust a movement speed of the tongue by shortening or lengthening the time of sequentially outputting the tongue position images. In the case of shortening the time, since the position of the tongue is changed slowly, it is useful to easily identify a part to be corrected.

Further, the English pronunciation correction apparatus may display a tongue standard position image on the display unit 125 for pronunciation correction of the user. To this end, the English pronunciation correction apparatus may further include a tongue standard image storage unit 130, a standard pronunciation practice manager 135 and a standard pronunciation display controller 140. The standard pronunciation practice manager 135 may be embodied as software modules executable by the processor. The standard pronunciation display controller 140 may be implemented in a display driver IC. The tongue standard image storage unit 130 may store a tongue standard position image for each phonetic symbol. In one embodiment, the tongue standard image storage unit 130 may store formant information of phonetic symbols and tongue standard position images corresponding thereto. The standard pronunciation practice manager 135 may provide a user interface for pronunciation practice as a component for aiding the user to practice the pronunciation. For example, the standard pronunciation practice manager 135 may allow the user to select a target language for the pronunciation practice through the user interface, and allow the user to select a target phonetic symbol for the pronunciation practice, which belongs to the selected language. Therefore, the user may select a language to be learned and a phonetic symbol belonging to the selected language through an operation unit 145. The operation unit 145 may be a touch input means, or a key input means in hardware.

The standard pronunciation practice manager 135 may retrieve and read a tongue standard position image corresponding to the phonetic symbol selected as a target of the practice from the tongue standard image storage unit 130. The standard pronunciation practice manager 135 may output one or more tongue standard position images read from the tongue standard image storage unit 130 to the standard pronunciation display controller 140. In one embodiment, the standard pronunciation practice manager 135 may generate one or more tongue standard position images as a 3D image, and output the 3D image to the standard pronunciation display controller 140. Alternatively, the image itself may be stored in a 3D format. The standard pronunciation display controller 140 displays one or more tongue standard position images inputted from the standard pronunciation practice manager 135 on the display unit 125. If a plurality of images are inputted, the standard pronunciation display controller 140 may represent the movement of a tongue position change by sequentially and continuously displaying a series of tongue standard position images according to the control of the standard pronunciation practice manager 135. In this way, since the user may compare the standard position of the tongue with the position of his/her own tongue through the screen of the display unit 125, the user may easily identify and correct a wrong part.

Further, the standard pronunciation practice manager 135 may adjust the playback speed of a series of tongue standard position images to be displayed on the screen by controlling the standard pronunciation display controller 140. Further, the adjustment of the speed may be achieved in accordance with the command of the user through the operation unit 145. Further, the standard pronunciation practice manager 135 may adjust the playback speed of a series of tongue position images to be displayed on the screen by controlling the tongue position display controller 120. The adjustment of the speed may also be achieved in accordance with the command of the user through the operation unit 145.

Further, the standard pronunciation practice manager 135 may display the tongue standard position image and the tongue position image of the user by synchronizing the display control of the tongue position display controller 120 with the display control of the standard pronunciation display controller 140. In this manner, it is possible to further facilitate the visual comparison by the user.

Moreover, the pronunciation correction apparatus may further include a camera 150, a face image processing unit 155 and a lip shape display controller 160. The face image processing unit 155 may be embodied as software modules executable by the processor. The lip shape display controller 160 may be implemented in a display driver IC.

The camera 150 captures an image of the face of the user practicing the pronunciation. In this case, an image of only a portion of the face including lips may also be captured. The face image processing unit 155 processes the face image of the user inputted from the camera 150. In one embodiment, “processing the face image” may mean analyzing the face image, extracting a specific portion including lips of the user, and scaling the extracted portion in a proper size.

The lip shape display controller 160 displays a lip image inputted from the face image processing unit 155 on the display unit 125. Accordingly, the user may visually check the shape of his/her own mouth when pronouncing phonetic symbols, which is helpful in correction.

Moreover, the pronunciation correction apparatus may display a lip standard shape image on the display unit 125 in order to assist the user in pronunciation correction. To this end, the pronunciation correction apparatus may further include a lip standard image storage unit 165. The lip standard image storage unit 165 may store a lip standard shape image for each phonetic symbol.

In one embodiment, the lip standard image storage unit 165 may store formant information of phonetic symbols and lip standard shape images corresponding thereto. The standard pronunciation practice manager 135 may read one or more lip standard shape images corresponding to the phonetic symbol selected as a target of the pronunciation practice from the lip standard image storage unit 165 and output the lip standard shape images to the standard pronunciation display controller 140.

The standard pronunciation display controller 140 displays one or more lip standard shape images inputted from the standard pronunciation practice manager 135 on the display unit 125. If a plurality of images is inputted, the standard pronunciation display controller 140 may represent the movement of a lip shape change by sequentially and continuously displaying a series of lip standard shape images according to the control of the standard pronunciation practice manager 135. Further, the standard pronunciation practice manager 135 may adjust the playback speed of a series of lip standard shape images to be displayed on the screen by controlling the standard pronunciation display controller 140. Further, the adjustment of the speed may be achieved in accordance with the command of the user through the operation unit 145. In this way, since the user may compare the standard shape of lips with the shape of his/her own lips through the screen of the display unit 125, the user may easily identify and correct a wrong part.

Meanwhile, the face image processing unit 155 may analyze the face image of the user inputted from the camera 150 to recognize a facial contour, and process the image in the same form as the lip standard shape image. In this case, the lip standard shape image may be an image between a nose and a jaw tip including lips. In one embodiment, the face image processing unit 155 may recognize a portion between the nose and the jaw tip of the facial contour, extract an image of only a portion between the nose and the jaw tip from the face image, and scale the extracted image in the same size as the lip standard shape image. Thus, it is possible to more easily compare the standard shape of the lips with the shape of the user's lips.

Further, the standard pronunciation practice manager 135 may simultaneously display the lip standard shape image and the lip shape image of the user by synchronizing the display control of the lip shape display controller 160 with the display control of the standard pronunciation display controller 140. In this manner, it is possible to further facilitate the visual comparison by the user.

Meanwhile, the pronunciation analysis unit 110, the tongue position image generator 115, the tongue position display controller 120 and the tongue standard image storage unit 130 may be excluded from the components of the English pronunciation correction apparatus shown in FIG. 1. That is, the English pronunciation correction apparatus may also display only a lip shape such that the pronunciation can be corrected by using only the lip shape.

According to the above-described configuration, first, after checking the position of the tongue when correctly pronouncing a phonetic symbol in a 3D animation, learning may be conducted while comparing the lip shape in the 3D animation with the shape of the user's lips by using an image camera. Further, by allowing the user to first check the position of the tongue when correctly pronouncing a phonetic symbol in the 3D animation, and displaying the position and movement of the tongue of the user pronouncing the phonetic symbol through the simulation, it is possible to enable the user to conduct comparison learning.

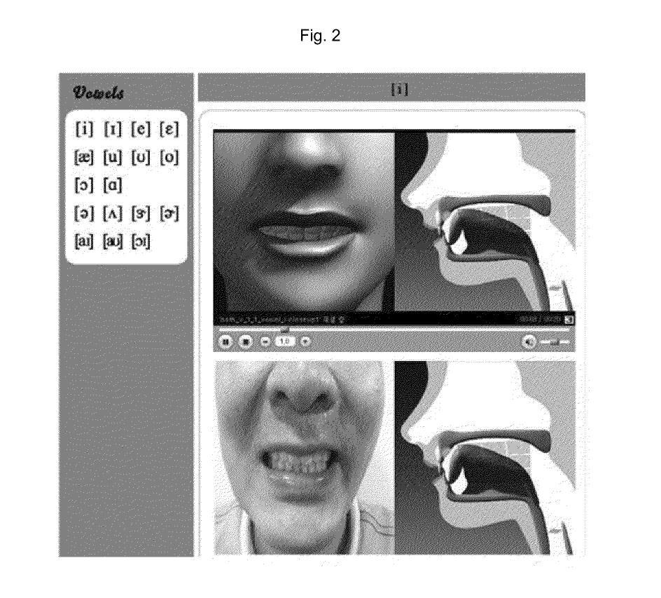

FIG. 2 is a diagram showing an example of a display screen representing the lip shape and the tongue position for phonetic symbol [i]. Vowels are arranged on the left side of the screen. The user may select a vowel whose pronunciation is intended to be practiced, and practice the pronunciation of the selected vowel. Alternatively, the pronunciation practice can be conducted sequentially in the order of the arranged vowels instead of selecting only one of the vowels. FIG. 2 illustrates an example of the practice for phonetic symbol [i] among vowel phonetic symbols. In FIG. 2, an upper left image is a lip standard shape image when pronouncing [i], and a lower left image is a lip shape image of the user pronouncing [i]. Further, an upper right image is a tongue standard position image when pronouncing [i], and a lower right image is a tongue position image of the user pronouncing [i]. Therefore, the user may check whether the shape of his/her own lips for the pronunciation of [i] is wrong through the left images displayed on the screen, and check whether the position of his/her own tongue for the pronunciation of [i] is wrong through the right images displayed on the screen. Further, as described above, the face image processing unit 155 may analyze the face image of the user to recognize a facial contour, and process the image in the same form as the lip standard shape image. Thus, as illustrated, the lip shape image of the user is displayed similarly to the lip standard shape image.

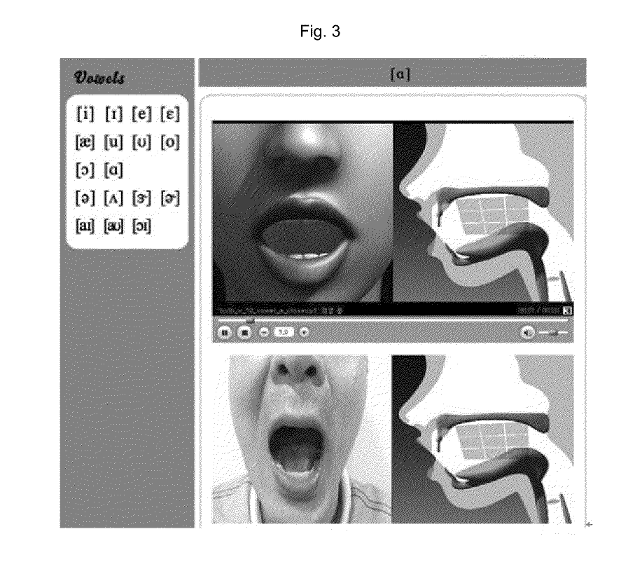

FIG. 3 is a diagram showing an example of a display screen representing the lip shape and the tongue position for phonetic symbol [a]. Vowels are arranged on the left side of the screen. FIG. 3 illustrates an example of the practice for phonetic symbol [a] among vowel phonetic symbols. In FIG. 3, an upper left image is a lip standard shape image when pronouncing [a], and a lower left image is a lip shape image of the user pronouncing [a]. Further, an upper right image is a tongue standard position image when pronouncing [a], and a lower right image is a tongue position image of the user pronouncing [a]. Therefore, the user may check whether the shape of his/her own lips for the pronunciation of [a] is wrong through the left images displayed on the screen, and check whether the position of his/her own tongue for the pronunciation of [a] is wrong through the right images displayed on the screen.

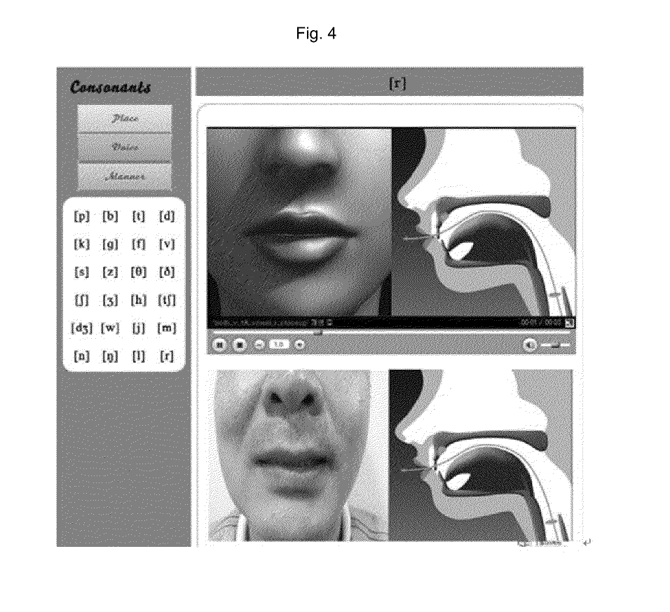

FIG. 4 is a diagram showing an example of a display screen representing the lip shape and the tongue position for phonetic symbol [r]. Consonants are arranged on the left side of the screen. The user may select a consonant whose pronunciation is intended to be practiced, and practice the pronunciation of the selected consonant. FIG. 4 illustrates an example of the practice for phonetic symbol [r] among consonant phonetic symbols. In FIG. 4, an upper left image is a lip standard shape image when pronouncing [r], and a lower left image is a lip shape image of the user pronouncing [r]. Further, an upper right image is a tongue standard position image when pronouncing [r], and a lower right image is a tongue position image of the user pronouncing [r]. Therefore, the user may check whether the shape of his/her own lips for the pronunciation of [r] is wrong through the left images displayed on the screen, and check whether the position of his/her own tongue for the pronunciation of [r] is wrong through the right images displayed on the screen.

Meanwhile, the pronunciation analysis unit 110 may analyze the user's pronunciation by using any one of a plurality of pronunciation analysis methods. The pronunciation analysis methods include the above-described method of analyzing formants of the pronunciation. Also, the pronunciation analysis methods may include a method of analyzing a Fast Fourier Transform (FFT) spectrum. The pronunciation analysis unit 110 may analyze the pronunciation of the user by using an appropriate analysis method according to the phonetic symbol which is intended to be practiced by the user. To this end, the standard pronunciation practice manager 135 may determine the analysis method according to the phonetic symbol specified by the user as a target for the pronunciation practice.

In one embodiment, the standard pronunciation practice manager 135 may determine a formant analysis method as the pronunciation analysis method if the phonetic symbol specified by the user as a target for the pronunciation practice is a vowel, and may also determine a formant analysis method as the pronunciation analysis method if the phonetic symbol is a nasal or liquid consonant. Further, if the phonetic symbol is a fricative consonant, a FFT spectrum analysis method may be determined as the pronunciation analysis method. As examples of the fricative consonant, there are English phonetic symbols [θ], [s] and [∫].

The pronunciation analysis unit 110 may analyze the user's pronunciation by the FFT spectrum analysis method if the phonetic symbol is a plosive consonant. The pronunciation analysis unit 110 may analyze energy distribution according to the frequency bands of the FFT spectrum, and also analyze a range of the peak frequency band. The maximum energy is formed at the peak frequency band. Further, the tongue position image generator 115 may generate the tongue position image by simulating the position of the tongue based on the analysis results of the pronunciation analysis unit 110.

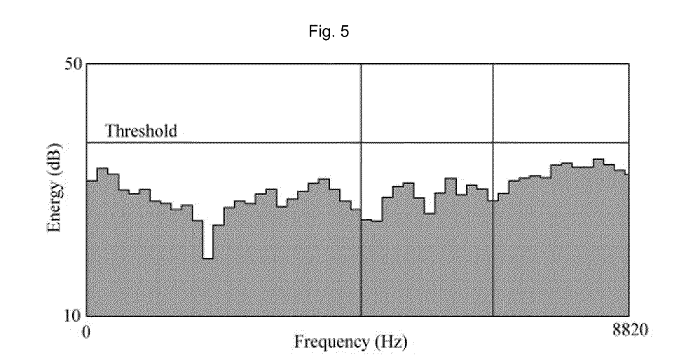

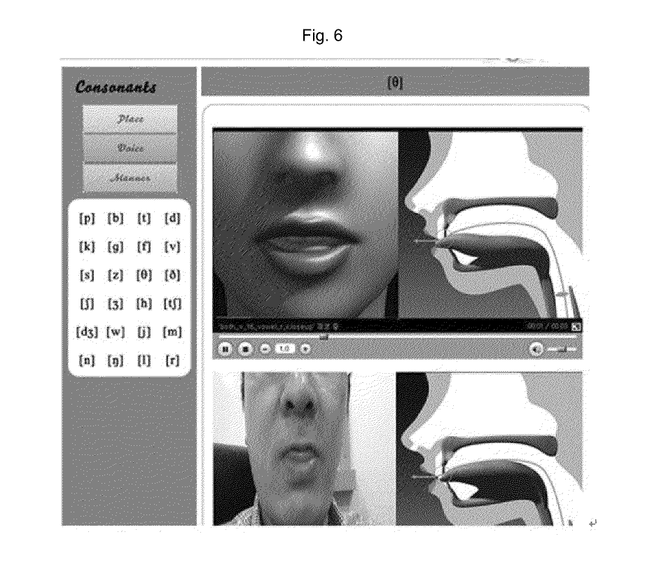

Let us review the pronunciation of the fricative consonant [θ]. In the case of the pronunciation of [θ], when analyzing the frequency of the FFT spectrum, as shown in FIG. 5, the energy is distributed over the entire band from 0 to 8000 Hz. Further, on the basis of a threshold value, when there is no frequency band higher than the threshold value, the tongue position image such as the lower right image of FIG. 6 may be displayed by 3D video simulation. In this case, the threshold value may be an adjustable energy value which is determined according to a change in energy magnitude rather than a fixed value. Since the decibel level of the voice is different for each person, the threshold value may not be set to a fixed value. That is, the threshold value may be determined actively in accordance with a change in decibel level of the user's voice.

In FIG. 6, an upper left image is a lip standard shape image when pronouncing [θ], and a lower left image is a lip shape image of the user pronouncing [θ]. Further, an upper right image is a tongue standard position image when pronouncing [θ], and a lower right image is a tongue position image of the user pronouncing [θ]. Therefore, the user may check whether the shape of his/her own lips for the pronunciation of [θ] is wrong through the left images displayed on the screen, and check whether the position of his/her own tongue for the pronunciation of [θ] is wrong through the right images displayed on the screen.

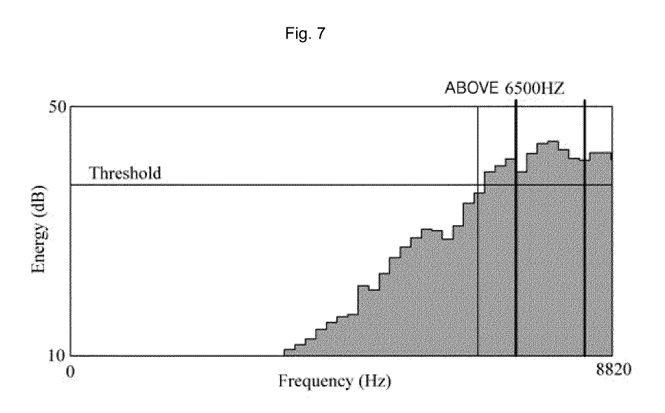

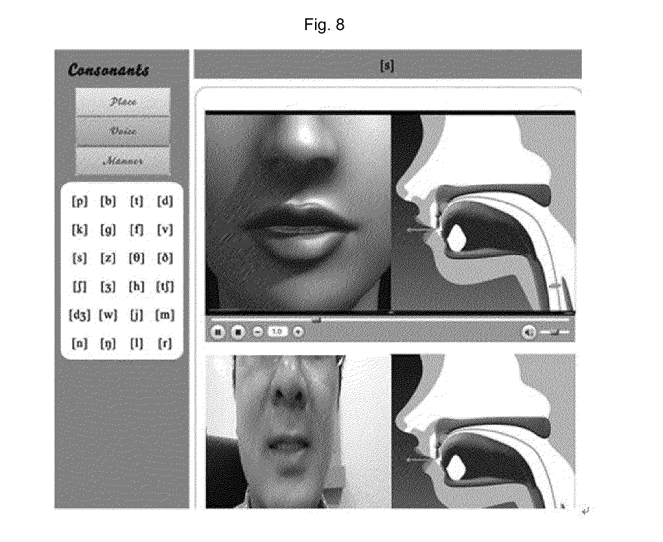

Let us review the pronunciation of the fricative consonant [s]. In the case of the pronunciation of [s], when analyzing the frequency of the FFT spectrum, as shown in FIG. 7, the energy of the low frequency band of 3000 Hz or less does not exist, and peak energy is distributed in the frequency band above 6500 Hz on the basis of the threshold value. As illustrated in FIG. 7, when energy is distributed differently according to the frequency on the FFT chart, the tongue position image such as the lower right image of FIG. 8 may be displayed by 3D video simulation.

In FIG. 8, an upper left image is a lip standard shape image when pronouncing [s], and a lower left image is a lip shape image of the user pronouncing [s]. Further, an upper right image is a tongue standard position image when pronouncing [s], and a lower right image is a tongue position image of the user pronouncing [s]. Therefore, the user may check whether the shape of his/her own lips for the pronunciation of [s] is wrong through the left images displayed on the screen, and check whether the position of his/her own tongue for the pronunciation of [s] is wrong through the right images displayed on the screen.

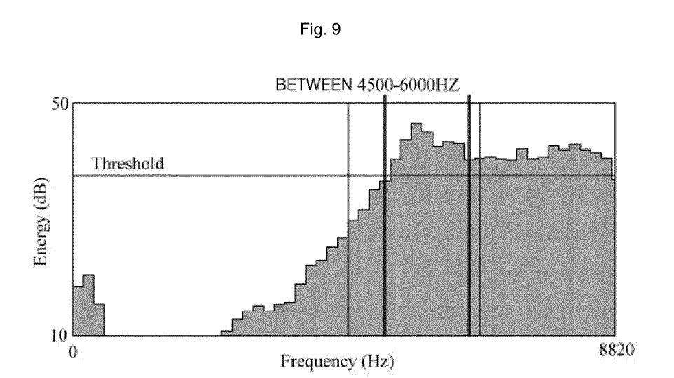

Further, if the user incorrectly pronounces [s] by failing to control the flow of air in the mouth, the position of articulation of [s] is changed. As illustrated in FIG. 9, if [s] is pronounced between 4500 and 6000 Hz rather than an original frequency band of [s], which is equal to or greater than 6500 Hz, the position of articulation is changed, and the position of the user's tongue may be outputted as a 3D simulated image on the screen based on the changed articulation point.

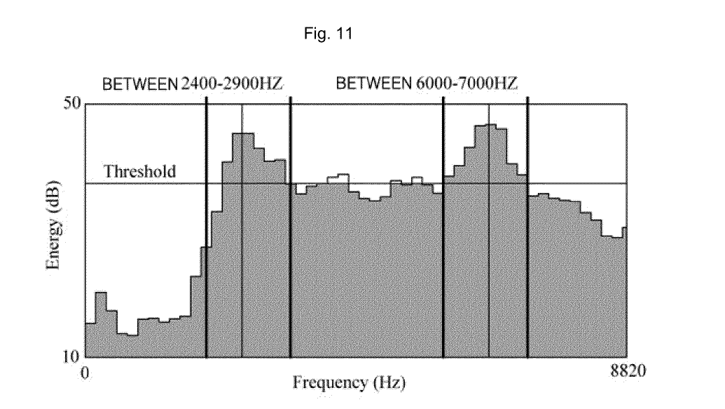

Let us review the pronunciation of the fricative consonant [∫]. In the case of the pronunciation of [s], when analyzing the frequency of the FFT spectrum, the maximum peak energy is present in a midrange between 2400 and 2900 Hz and a frequency band between 6000 and 7000 Hz on the basis of the threshold value. As illustrated in FIG. 11, when energy is distributed differently according to the frequency on the FFT chart, the tongue position image such as the lower right image of FIG. 128 may be displayed by 3D video simulation.

On the other hand, with regard to plosive consonants, a method of analyzing the duration of Voice Onset Time (VOT) may be used. As examples of plosive consonants which should be pronounced explosively at once after completely closing the articulation position of the mouth, there are [p], [b], [t], [d], [k] and [g]. If the phonetic symbol is a plosive consonant, the pronunciation analysis unit 110 analyzes the duration of voice onset time from a time point when plosion is generated by a pressure on a contact area to a time point when the vocal cords vibrate to vocalize a vowel to be pronounced subsequently. However, it is impossible to determine whether the plosive consonant is a bilabial consonant such as [p] and [b] occurring in both lips, an alveolar consonant such as [t] and [d] in which articulation occurs in the upper gums, or a velar consonant such as [k] and [g] in which articulation occurs in the soft palate by using only the VOT in an actual waveform. However, since the phonetic symbol to be pronounced by the user is specified in advance, it is possible to know whether the phonetic symbol is a bilabial consonant, an alveolar consonant or a velar consonant before the VOT analysis. Therefore, the pronunciation analysis unit 110 may analyze the pronunciation of the user while knowing whether the phonetic symbol to be pronounced by the user is a bilabial consonant, an alveolar consonant or a velar consonant.

However, in the case of plosive consonants, since the vocalization is actually more problematic than the position of the tongue, a method of correcting the position of the tongue may be inappropriate. Therefore, with regard to plosive consonants, a process of generating the tongue position image from the pronunciation of the user and displaying the tongue position image may not be performed.

The pronunciation correction apparatus may further include a pronunciation evaluation unit 170. The pronunciation evaluation unit 170 may evaluate the pronunciation of the user if the phonetic symbol specified as a target for the pronunciation practice is a liquid consonant. For example, as the liquid consonant, there are [l] and [r]. In one embodiment, the pronunciation evaluation unit 170 may evaluate the pronunciation of the user by linear predictive coding (LPC) waveform analysis.

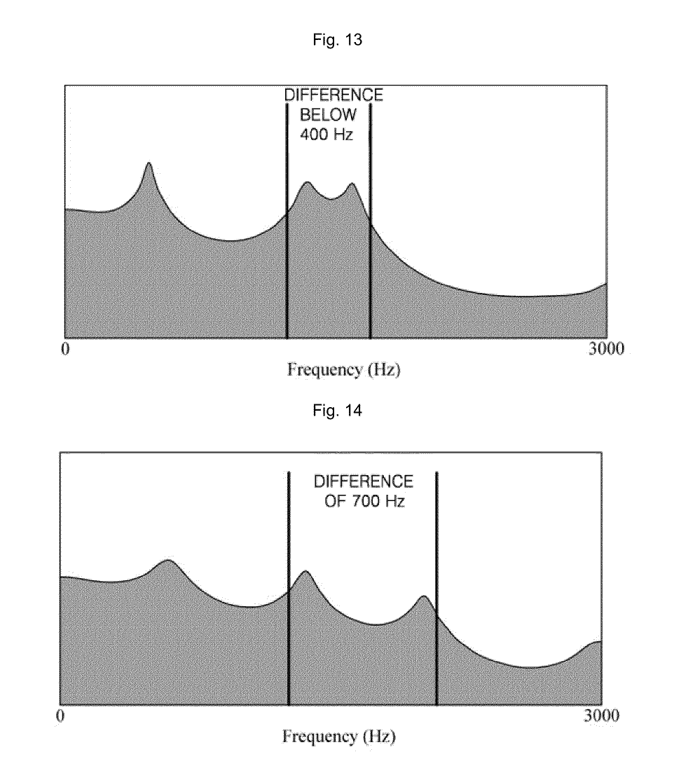

Let us review the pronunciation of the liquid consonant [r]. According to the test results carried out for an actual learner for a long time, if the pronunciation of [r] is correct, an interval between the formant frequencies F2 and F3 should be equal to or less than a predetermined reference value. The reference value may be, for example, 400 Hz. Therefore, by using linear predictive coding (LPC) waveform analysis, if the interval between the formant frequencies F2 and F3 is equal to or less than 400 Hz as illustrated in FIG. 13, the pronunciation evaluation unit 170 may evaluate the pronunciation as complete pronunciation of [r] and provide a score of 100 points to the user through the display unit 125. However, if the interval between the formant frequencies F2 and F3 exceeds 400 Hz as illustrated in FIG. 14, the pronunciation evaluation unit 170 may evaluate the pronunciation as incorrect pronunciation of [r], and may provide a score obtained out of 100 points according to the interval difference between the formant frequencies F2 and F3 to the user through the display unit 125. The larger the value of (interval between F2 and F3—400 Hz), the lower the score of the pronunciation.

When evaluating the pronunciation of [r], the interval between F1 and F2 may also be taken into consideration in addition to the interval between F2 and F3. According to the test results carried out for an actual learner for a long time, if the pronunciation of [r] is correct, an interval between the formant frequencies F1 and F2 is preferably within a predetermined range. The predetermined range may be, for example, a range from 700 Hz to 850 Hz. More preferably, the predetermined range may be a range from 750 Hz to 800 Hz.

According to the test results carried out for an actual learner for a long time, the male voice have the formants F1, F2 and F3 formed at different positions from those of the female voice when pronouncing [r]. However, if the pronunciation of [r] is correct, the intervals between F1, F2 and F3 meet the same requirements regardless of gender. That is, the interval between F1 and F2 has a value ranging from 700 Hz to 850 Hz (preferably, from 750 Hz to 800 Hz), and the interval between F2 and F3 has a value equal to or greater than 400 Hz.

In short, the pronunciation evaluation unit 170 according to one embodiment may evaluate the pronunciation of [r] only by using the interval between F1 and F2. The pronunciation evaluation unit 170 according to another embodiment may evaluate the pronunciation of [r] only by using the interval between F2 and F3. The pronunciation evaluation unit 170 according to still another embodiment may evaluate the pronunciation of [r] by considering both the interval between F1 and F2 and the interval between F2 and F3.

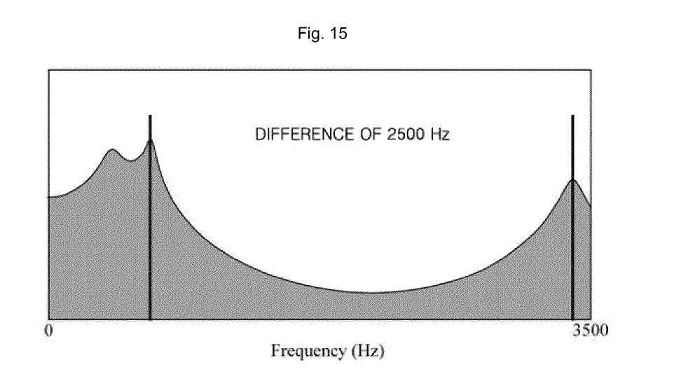

Let us review the pronunciation of the liquid consonant [l]. By using linear predictive coding (LPC) waveform analysis, if the interval between the formant frequencies F2 and F3 is equal to or greater than 2500 Hz as illustrated in FIG. 15, the pronunciation evaluation unit 170 may evaluate the pronunciation as complete pronunciation of [l] and provide a score of 100 points to the user through the display unit 125. However, if the interval between the formant frequencies F2 and F3 is less than 2500 Hz, the pronunciation evaluation unit 170 may evaluate the pronunciation as incorrect pronunciation of [l], and may provide a score obtained out of 100 points according to the interval difference between the formant frequencies F2 and F3 to the user through the display unit 125. The smaller the interval difference between F2 and F3, the lower the score of the pronunciation.

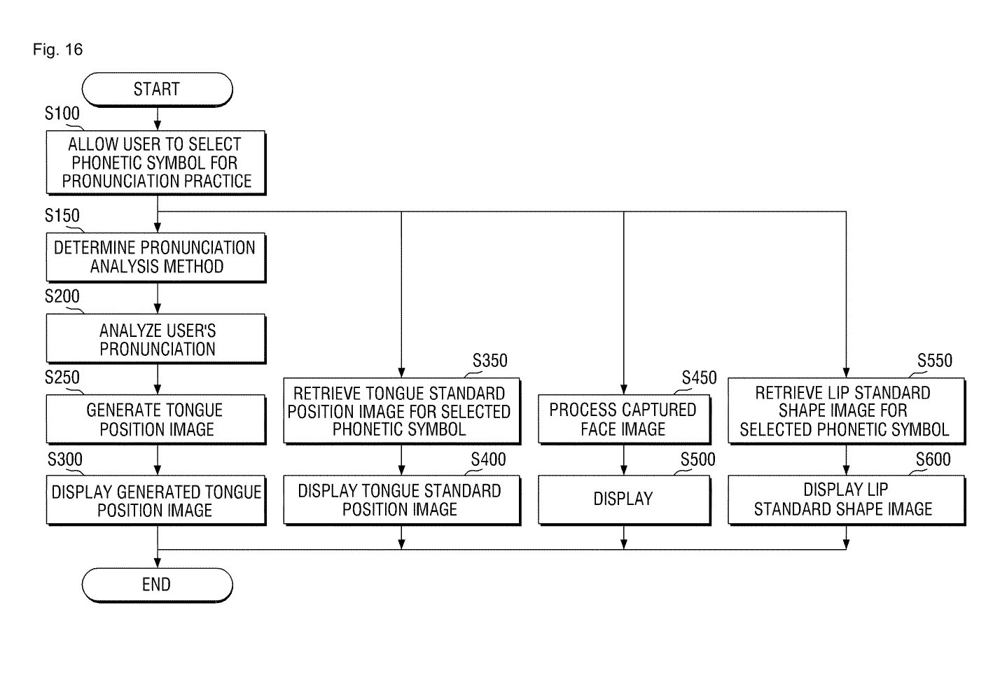

FIG. 16 is a flowchart of a pronunciation correction method according to one embodiment of the present invention. The standard pronunciation practice manager 135 allows the user to select a language and a phonetic symbol for pronunciation practice (step S100). If the phonetic symbol is selected, the standard pronunciation practice manager 135 determines a pronunciation analysis method. In one embodiment, if the phonetic symbol is a vowel, a formant analysis method is determined as the pronunciation analysis method, and if the phonetic symbol is a fricative consonant, a FFT spectrum analysis method is determined as the pronunciation analysis method (step S150). The pronunciation analysis unit 110 analyzes the pronunciation of the user for the selected phonetic symbol, and analyzes the pronunciation of the user by using the determined pronunciation analysis method (step S200). In this case, the pronunciation analysis unit 110 may analyze the pronunciation of the user by using any one of a plurality of pronunciation analysis methods. The pronunciation analysis methods may include a formant analysis method and a FFT spectrum analysis method. The standard pronunciation practice manager 135 may determine the pronunciation analysis method for the selected phonetic symbol, and notify the determined pronunciation analysis method to the pronunciation analysis unit 110. Accordingly, the pronunciation analysis unit 110 analyzes the pronunciation of the user by the determined pronunciation analysis method.

The tongue position image generator 115 generates the tongue position image on the basis of the analysis results obtained by the pronunciation analysis unit 110 (step S250). In this case, the tongue position image generator 115 may generate an image by estimating the position of the tongue in the side view. If the tongue position image is generated, the tongue position display controller 120 displays the generated tongue position image on the display unit 125 (step S300). Meanwhile, the standard pronunciation practice manager 135 retrieves and reads the tongue standard position image for the phonetic symbol selected at step S100 from the tongue standard image storage unit 130 (step S350). The standard pronunciation display controller 140 displays the read tongue standard position image on the display unit 125 (step S400).

In the above process, if the selected phonetic symbol is a liquid consonant, the pronunciation evaluation unit 170 may evaluate the pronunciation of the user, and the evaluation results may be displayed on the display unit 125. In this case, the pronunciation evaluation unit 170 may evaluate the pronunciation of the user by linear predictive coding (LPC) waveform analysis. Further, among the steps, step S150 may be omitted, and in this case, only one pronunciation analysis method may be used.

On the other hand, the face image processing unit 155 processes the face image inputted from the camera 150 which captures an image of the face of the user pronouncing the phonetic symbol (step S450). At this time, the face image processing unit 155 may analyze the face image, extract a specific portion including lips of the user, and scale the extracted portion in a proper size. The lip shape display controller 160 displays the lip image processed by the face image processing unit 155 on the display unit 125 (step S500). Meanwhile, the standard pronunciation practice manager 135 retrieves and reads the lip standard shape image for the phonetic symbol selected at step S100 from the lip standard image storage unit 165 (step S550). The standard pronunciation display controller 140 displays the read lip standard shape image on the display unit 125 (step S600).

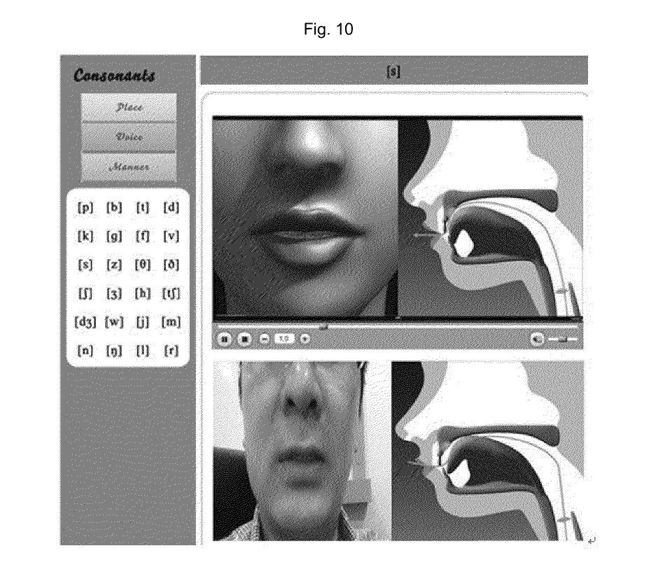

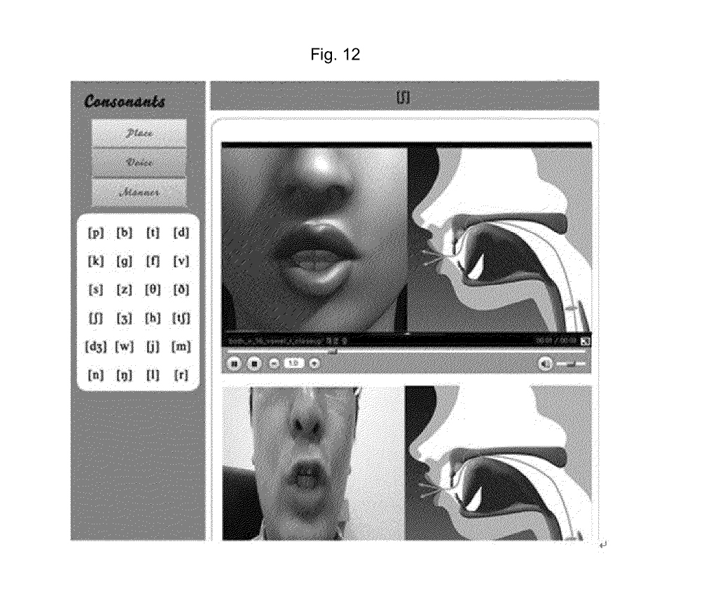

This invention, explained by referring FIGS. 1-16, may be implemented by using a computer readable code on a non-transitory machine-readable medium. For example, a computer program product comprising a non-transitory machine-readable medium storing instructions that, when executed by at least one programmable processor, cause the at least one programmable processor to perform operations comprising may be provided for the implementation of this invention.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A pronunciation correction apparatus comprising:
a pronunciation analysis unit to receive an audio signal of a user and analyze pronunciation of the user; and
a tongue position image generator to generate a tongue position image indicating a position of a tongue in the pronunciation of the user from the analysis results of the pronunciation analysis unit.

2. The pronunciation correction apparatus of claim 1, wherein the tongue position image generator estimates the position of the tongue in a side view based on the pronunciation analysis results of the pronunciation analysis unit.

3. The pronunciation correction apparatus of claim 1, further comprising a standard pronunciation practice manager to determine a pronunciation analysis method based on a phonetic symbol specified as a target for pronunciation practice,
wherein the pronunciation analysis unit analyzes the pronunciation by using the determined pronunciation analysis method.

4. The pronunciation correction apparatus of claim 3, wherein the pronunciation analysis unit analyzes formants of the pronunciation if the phonetic symbol specified as a target for pronunciation practice is a vowel, or a nasal or liquid consonant.

5. The pronunciation correction apparatus of claim 3, wherein the pronunciation analysis unit analyzes a Fast Fourier Transform (FFT) spectrum of the pronunciation if the phonetic symbol specified as a target for pronunciation practice is a fricative consonant.

6. The pronunciation correction apparatus of claim 3, further comprising a pronunciation evaluation unit to evaluate the pronunciation by linear predictive coding (LPC) waveform analysis if the phonetic symbol specified as a target for pronunciation practice is a liquid consonant.

7. The pronunciation correction apparatus of claim 3, further comprising:
a tongue standard image storage unit to store a tongue standard position image for each phonetic symbol;
a standard pronunciation display controller to output an input image to a display unit; and
a standard pronunciation practice manager to read a tongue standard position image corresponding to the phonetic symbol specified as a target for pronunciation practice from the tongue standard image storage unit and output the tongue standard position image to the standard pronunciation display controller.

8. The pronunciation correction apparatus of claim 7, further comprising:
a face image processing unit to process a captured face image of the user; and
a lip shape display controller to display the processed image on the display unit.

9. The pronunciation correction apparatus of claim 8, further comprising a lip standard image storage unit to store a lip standard shape image for each phonetic symbol,
wherein the standard pronunciation practice manager reads a lip standard shape image corresponding to the phonetic symbol specified as a target for pronunciation practice from the lip standard image storage unit and displays the lip standard shape image.

10. The pronunciation correction apparatus of claim 9, wherein the face image processing unit analyzes the face image of the user to recognize a facial contour, and processes the image in the same form as the lip standard shape image.

11. A pronunciation correction method comprising:
receiving an audio signal constituting pronunciation of a user for a phonetic symbol selected as a target to be practiced;
analyzing the audio signal;
generating a tongue position image according to the audio signal based on the analysis results; and
displaying the generated tongue position image.

12. The pronunciation correction method of claim 11, wherein the displaying the generated tongue position image comprises further displaying a tongue standard position image for the phonetic symbol.

13. The pronunciation correction method of claim 11, wherein the analyzing the audio signal comprises:
selecting one of a plurality of pronunciation analysis methods according to the phonetic symbol; and
analyzing the audio signal by using the selected pronunciation analysis method.

14. The pronunciation correction method of claim 13, wherein the plurality of pronunciation analysis methods include a method of analyzing formants of the pronunciation and a method of analyzing a Fast Fourier Transform (FFT) spectrum of the pronunciation.

15. The pronunciation correction method of claim 11, further comprising evaluating the pronunciation of the user by linear predictive coding (LPC) waveform analysis if the selected phonetic symbol is a liquid consonant.

16. The pronunciation correction method of claim 15, wherein the evaluating the pronunciation of the user comprises evaluating the pronunciation of the user by evaluating whether an interval between formant frequencies F2 and F3 of the pronunciation is equal to or less than a predetermined reference value if the selected phonetic symbol is [r].

17. The pronunciation correction method of claim 16, wherein the evaluating the pronunciation of the user comprises evaluating the pronunciation of the user by further evaluating whether an interval between formant frequencies F1 and F2 of the pronunciation is within a predetermined range if the selected phonetic symbol is [r].

18. The pronunciation correction method of claim 11, further comprising:
displaying a face image of the user pronouncing a phonetic symbol; and
displaying a lip standard shape image for the phonetic symbol being pronounced by the user.

19. The pronunciation correction method of claim 11, wherein the analyzing the audio signal comprises calculating formant frequencies F1 and F2 of the pronunciation of the user, and
wherein the generating the tongue position image comprises:
generating feature points corresponding to the formant frequencies F1 and F2; and
generating the tongue position image by using the feature points as an application point and an end point of a tongue in a Bezier curve which is a curve in a length direction of the tongue when viewed from a side of a face.
